(19) United States
(12) Patent Application Publication
(10) Pub. No.: US 2025/0102644 A1
(43) Pub. Date: Mar. 27, 2025

(54) TDC DEVICE AND RANGING APPARATUS

(71) Applicant: CANON KABUSHIKI KAISHA, Tokyo (JP)

(72) Inventors: WATARU ENDO, Tokyo (JP); HIROYUKI MUTO, Kanagawa (JP)

(21) Appl. No.: 18/890,995

(22) Filed: Sep. 20, 2024

(30) Foreign Application Priority Data
Sep. 25, 2023 (JP) 2023-159942

(51) Int. Cl. G01S 7/4865; G01S 7/481; G01S 17/894

(52) U.S. Cl. CPC G01S 7/4865; G01S 7/4816; G01S 17/894

(57) ABSTRACT

A TDC device includes: a plurality of TDC circuits; a clock supply unit configured to supply a common clock signal to the TDC circuits; and a start control unit configured to output a count start signal instructing a start timing of a counting operation to the TDC circuits. The start control unit outputs the count start signal after a predetermined delay time has passed since a timing when supply of the common clock signal is started from the clock supply unit to the TDC circuits.

### BACKGROUND OF THE INVENTION

### Field of the Invention

The present disclosure relates to a TDC device, and a ranging apparatus.

### Description of the Related Art

Photoelectric conversion devices that can detect feeble light that is at a single photon level by the use of avalanche multiplication are known. U.S. Patent Application Publication No. 2017/0186798 discloses, in the description thereof, a photoelectric conversion device including a sensor chip where a plurality of pixels are arranged, and a circuit chip where a circuit via which signal processing is carried out is formed: both of which are electrically connected in a stacked structure. It is also disclosed that avalanche photodiodes (APDs) where charge causes avalanche multiplication are used for the pixels in the sensor chip of the foregoing photoelectric conversion device.

As one example of application of photoelectric conversion devices, it is known that the distance to an object is measured by the time difference between the timing when light is emitted and the timing when reflected light from the object is detected. Ranging apparatuses of this type are called optical time-of-flight (TOF) sensors. TOF sensors capable of acquiring three-dimensional information on, or a depth map of a subject by the use of pixel arrays where pixels having photoelectric conversion elements are two-dimensionally arranged are also referred to as TOF cameras or 3D measurement devices.

For example, Japanese Patent Application Publication No. 2022-124396 discloses counting, in a TOF sensor, the elapsed time until reflected light is detected using a time-to-digital converter that is hereinafter referred to as a TDC.

### SUMMARY OF THE INVENTION

The present disclosure includes a time-to-digital converter (TDC) device including: a plurality of TDC circuits; a clock supply unit configured to supply a common clock signal to the TDC circuits; and a start control unit configured to output a count start signal instructing a start timing of a counting operation to the TDC circuits, wherein the start control unit outputs the count start signal after a predetermined delay time has passed since a timing when supply of the common clock signal is started from the clock supply unit to the TDC circuits

Further features of the present invention will become apparent from the following description of exemplary embodiments with reference to the attached drawings.

### BRIEF DESCRIPTION OF THE DRAWINGS

FIG. 1 is a block diagram showing an example of configuration of a ranging apparatus;

FIG. 2 shows configuration of a photoelectric conversion device;

FIG. 3 shows an example of arrangement on a sensor substrate;

FIG. 4 shows an example of arrangement on a circuit board;

FIGS. 5A and 5B are block diagrams each including an equivalent circuit of a photoelectric conversion element;

FIG. 6 shows relationship between operation of an APD, and output signal;

FIG. 7 shows configuration of a TDC device according to a first embodiment;

FIG. 8 shows configuration of a start control unit according to the first embodiment;

FIG. 9 is a timing chart of start control according to the first embodiment;

FIG. 10 is a timing chart of start control according to a comparative example;

FIG. 11 shows configuration of the TDC device according to a second embodiment;

FIG. 12 shows configuration of a start control unit according to the second embodiment;

FIG. 13 shows configuration of a delay circuit according to the second embodiment;

FIGS. 14A and 14B are timing charts of start control according to the second embodiment;

FIG. 15 is a block diagram including an equivalent circuit of a photoelectric conversion element according to a third embodiment;

FIG. 16A illustrates a vehicle-mounted camera system according to a fourth embodiment;

FIG. 16B illustrates a movable body according to the fourth embodiment; and

FIGS. 17A and 17B illustrate an electronic device according to a fifth embodiment.

### DESCRIPTION OF THE EMBODIMENTS

The present disclosure will be described. The disclosers of the present disclosure have researched simultaneously supplying a common clock signal to a plurality of columns of TDC circuits which corresponded to respective columns in a pixel array, and driving all the TDC circuits together. Because of such structure, the effects such as accelerated ranging and a simplified circuit configuration can be expected.

However, upon their further experiments, the disclosers of the present discloser found out that in the foregoing structure, due to a sudden change in the amount of the current flowing in the circuit when the common clock signal is simultaneously supplied, the power supply voltage for the TDC circuits may fluctuate. Such power-supply fluctuations may lead to faults in TD conversion, and further, failure or a decreased precision in ranging if occurring during the operation of the TDC circuits.

The larger the number of the TDC circuits to be driven simultaneously is, that is, the larger the number of the pixels, or columns, in the pixel array is, the larger the power-supply fluctuations are. The higher the temporal resolution of the TDC circuits is, the more easily the TDC circuits are influenced by power-supply fluctuations, and the higher the risk of the faults is. Therefore, further precision TOF sensors, and/or further improved TOF sensors in ranging resolution make it more difficult to ignore the aforementioned problem.

The present disclosure was made with the foregoing actual circumstances in view. An object of the present disclosure is to provide a feature for avoiding the influence of power-supply fluctuations in a TDC device where a common clock signal is supplied to a plurality of TDC circuits.

The following embodiments are for embodying technical ideas of the present disclosure, but do not limit the present disclosure. The sizes of, and the positional relationships between some members shown in the drawings are exaggerated for clarifying the description. In the following description, the components of the same type are denoted by the same number, and the description thereof may be omitted.

Hereinafter the embodiments of the present disclosure will be described in detail based on the drawings. In the following description, terms that mean specific directions and positions, such as “up”, “down”, “left”, “right”, and any other terms containing these terms, are used if necessary. These terms are used for facilitating the understanding of the embodiments with reference to the drawings. The meanings of these terms do not limit the technical scope of the present disclosure.

In this specification, a plan view is viewing in the direction vertical to a light incidence face of a semiconductor layer; and a cross-sectional view is from a face in the direction vertical to a light incidence face of a semiconductor layer. When a light incidence face of a semiconductor layer is microscopically a rough face, the plan view is defined on the basis of a light incidence face of the semiconductor layer when viewed macroscopically.

The semiconductor layer has a first face, and a second face which is on the opposite side of the first face and where light enters. In this specification, a depth direction is the direction from the first face of the semiconductor layer where avalanche photodiodes (APDs) are arranged to the second face of the semiconductor layer. Hereinafter, the “first face” may be referred to as a “front face”, and the “second face” may be referred to as a “back face”. A “depth” of some point or region in the semiconductor layer means the distance between this point or region, and the first face or front face. When there are the point or region Z1 and the point or region Z2, the distance between Z1 and the first face, that is, the depth of Z1 from the first face is d1 and the distance between Z2 and the first face, that is, the depth of Z2 from the first face is d2, and d1>d2, the expression “Z1 is deeper than Z2” or “Z2 is shallower than Z1” may be also used. When there is the point or region Z3, the distance between Z3 and the first face, that is, the depth of Z3 from the first face is d3, and the inequation d1>d3>d2 holds, the expression such as “the depth of Z3 is between Z1 and Z2” and “Z3 is between Z1 and Z2 in terms of the depth direction” may be also used.

In the following description, the anode of an avalanche photodiode (APD) is set to be at a fixed potential, and a signal is taken out from the cathode side thereof. Thus, a first conductivity type semiconductor region in which charge of the same polarity as signal charge is a majority carrier is an N-type semiconductor region, and a second conductivity type semiconductor region in which charge of the polarity different from signal charge is a majority carrier is a P-type semiconductor region. Even when the cathode of the APD is set to be at a fixed potential and a signal is taken out from the anode side, the present disclosure is implemented. In this case, a first conductivity type semiconductor region in which charge of the same polarity as signal charge is a majority carrier is a P-type semiconductor region, and a second conductivity type semiconductor region in which charge of the polarity different from signal charge is a majority carrier is an N-type semiconductor region. Hereinafter a case where one node of an APD is set to be at a fixed potential will be described, but the potentials of both nodes thereof may fluctuate.

In this specification, when simply used, the term “impurity concentration” means a net impurity concentration obtained by subtracting impurities of the opposite conductivity type for compensation. In short, the “impurity concentration” means a net doping concentration. A region where the P-type additive impurity concentration is higher than the N-type additive impurity concentration is a P-type semiconductor region. In contrast, a region where the N-type additive impurity concentration is higher than the P-type additive impurity concentration is an N-type semiconductor region.

In the following embodiments, connection between circuit elements may be described. In this case, even when another element is interposed between the focused elements, the focused elements are treated to be electrically connected unless otherwise specified. For example, even when an element A is connected to one node of a capacitive element C having a plurality of nodes, and an element B is connected to another node thereof, the elements A and B are treated to be electrically connected unless otherwise specified. A state where elements are connected without interposition of any other element therebetween may be expressed as direct connection. In the foregoing example, if any other element is not provided between the element A and the capacitive element C, the element A and the capacitive element C can be said to be directly connected.

The metal members described in this specification, such as wiring and pads, may be each made from a simple substance of a metal of one element, or may be a mixture or an alloy. For example, the wiring described as copper wiring may be made from a simple substance of copper, or may primarily contain copper and further contain any other components. For example, a pad connected to an external terminal may be made from a simple substance of aluminum, or may primarily contain aluminum and further contain any other components. The copper wiring and aluminum pad shown herein are examples, and the metals thereof can be changed to any various metals.

The wiring and pad shown herein are also examples of the metal members used in a photoelectric conversion device, and the above description is applicable to any other metal members.

In each of the embodiments described below, as one example of application of photoelectric conversion devices, an optical ranging apparatus, or a TOF sensor, that measures the distance to an object by the time difference between the timing when light is emitted and the timing when reflected light from the object is detected will be described mainly. These embodiments are not limited to ranging apparatuses, but are applicable to any other examples of photoelectric conversion devices such as imaging devices and photometers, that is, devices that measure the incident light quantity, etc.

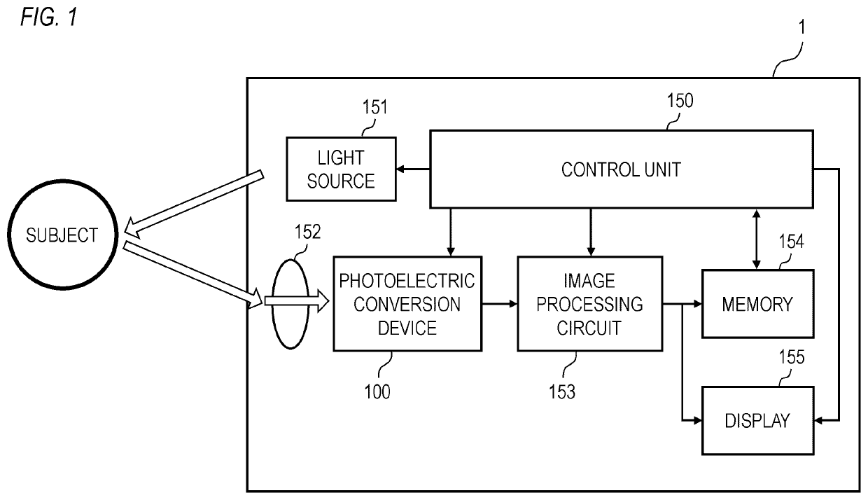

The configuration of a ranging apparatus, or a TOF sensor, according to one embodiment of the present disclosure will be described using FIG. 1. FIG. 1 is a block diagram showing an example of the configuration of the ranging apparatus.

As shown in FIG. 1, a ranging apparatus 1 includes a control unit 150, a light source 151, an optical system 152, a photoelectric conversion device 100, an image processing circuit 153, a memory 154, and a display 155. The ranging apparatus 1 emits light from the light source 151, and detects, in the photoelectric conversion device 100, reflected light reflected on a subject. Then, the time difference between the timing when the light is emitted and the timing when the reflected light is detected, which correspond to the time-of-flight of the light between the ranging apparatus 1 and the subject, is calculated; thereby, information on the distance to the subject is acquired.

For example, the light source 151 is a near-infrared laser light source of 850 nm to 940 nm. While visible light may be used, the use of invisible light such as near-infrared light is capable of ranging without a sense of a visual obstruction, which is advantageous. The light source 151 emits light for ranging to a subject according to an emission timing signal that is from the control unit 150. For example, modulated light, pulsed light, or the like is preferably used as the light for ranging.

The optical system 152 includes one or a plurality of lens(es), and guides the reflected light from a subject to the photoelectric conversion device 100 to form an image on a light receiving face, or a sensor part, of the photoelectric conversion device 100. As the major components, the photoelectric conversion device 100 has a pixel array where a plurality of pixels each having a photoelectric conversion element are two-dimensionally arranged, and a time-to-digital converter (TDC) device. A signal outputted from a pixel having detected the reflected light is converted in the TDC device to digital time information. The time information, or distance information that is the time information converted in terms of the distance, measured in each pixel is outputted to the image processing circuit 153. In the image processing circuit 153, one frame of a distance image is created based on the time information or distance information supplied from the photoelectric conversion device 100. For example, the distance image is a two-dimensional image including distance information or depth information as a pixel value, and is data representing the three-dimensional information on the subject. The distance image is also referred to as a depth map, three-dimensional data, etc. Dynamic image data on the distance image can be also created based on a plurality of frames of distance images continuously acquired by ranging at a predetermined frame rate. The data on the distance image created in the image processing circuit 153 may be stored, or recorded, in the memory 154, or may be displayed on the display 155. The data on the distance image may be transmitted to an external device via a cable or network which is not shown.

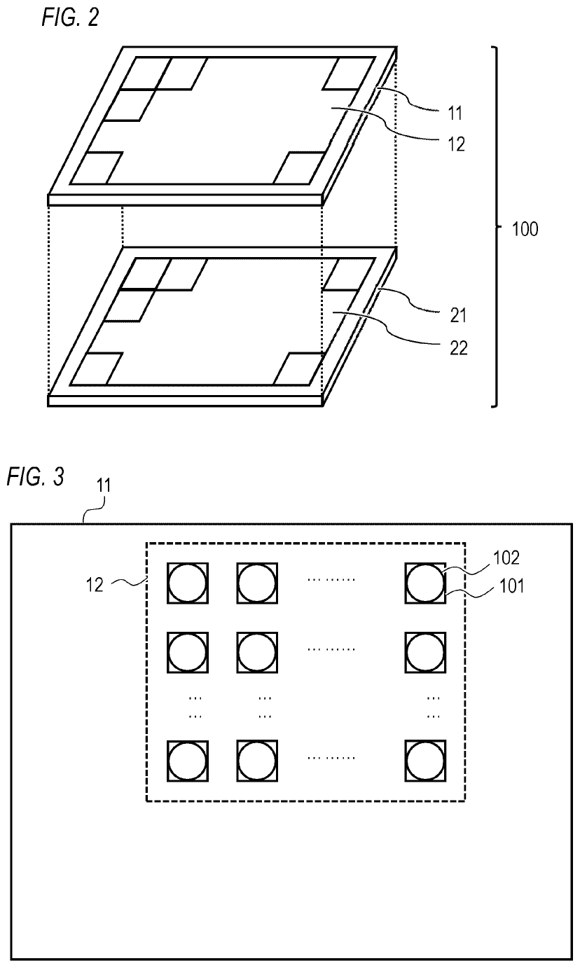

The structure of the photoelectric conversion device according to the present disclosure will be described using FIGS. 2 to 6.

FIG. 2 shows the structure of the photoelectric conversion device 100 in the embodiments of the present disclosure. Hereinafter a case where the photoelectric conversion device 100 is a stack-type photoelectric conversion device will be described as an example. In short, the photoelectric conversion device formed by stacking, and electrically connecting the two substrates of a sensor substrate 11 and a circuit board 21 will be described as an example. The photoelectric conversion device is, however, not limited to this. For example, the photoelectric conversion device may be a photoelectric conversion device where the components included in the sensor substrate 11, and the components included in the circuit board 21 are arranged in a common semiconductor layer, which will be described later. Hereinafter the photoelectric conversion device where the components included in the sensor substrate 11, and the components included in the circuit board 21 are arranged in a common semiconductor layer is also referred to as a non-stacked photoelectric conversion device.

The sensor substrate 11 has a first semiconductor layer having the undermentioned photoelectric conversion elements 102, and a first wiring structure. The circuit board 21 has a second semiconductor layer having the undermentioned circuits such as signal processing units 103, and a second wiring structure. The photoelectric conversion device 100 is configured by stacking the second semiconductor layer, the second wiring structure, the first wiring structure, and the first semiconductor layer in this order.

FIG. 2 shows a back-side illuminated photoelectric conversion device where light enters from a second face, or a back face, and the circuit board 21 is arranged on a first face, or a front face, that is on the opposite side of the second face. In the case of the non-stacked photoelectric conversion device, a face where transistors of signal processing circuits are arranged is referred to as the first face. In the case of a front-side illuminated photoelectric conversion device, a front face is the second face or a light incidence face, and a back face is the first face.

Hereinafter the sensor substrate 11 and the circuit board 21 will be described in the form of diced chip, but are not limited to chips. For example, the substrate and the board may be wafers. Alternatively, the substrate and the board may be each diced after stacked in the form of wafer. One may also chip the substrate and the board, and thereafter, stack and join each chip.

A pixel region 12 is disposed on the sensor substrate 11, and a circuit region 22 where signals detected in the pixel region 12 are processed is disposed on the circuit board 21.

FIG. 3 shows the arrangement of the sensor substrate 11. Pixels 101 having the photoelectric conversion elements 102 including avalanche photodiodes (APDs) are arranged two-dimensionally to form the pixel region 12. This pixel region 12 is also referred to as a pixel array.

Typically, the pixels 101 are pixels for forming images. When the pixels 101 are used for time-of-flight (TOF), it is not always necessary to form images. That is, the pixels 101 may be pixels for measuring the time point when light arrives. When the pixels are for forming images, pixel signals corresponding to the light quantity or charge quantity detected for a predetermined exposure period are outputted from the pixels 101. In contrast, when the pixels are for measuring the time point when light arrives, pixel signals are outputted at the timing when light is detected. The pixels 101 may work as both pixels for forming images, and pixels for measuring the time point when light arrives.

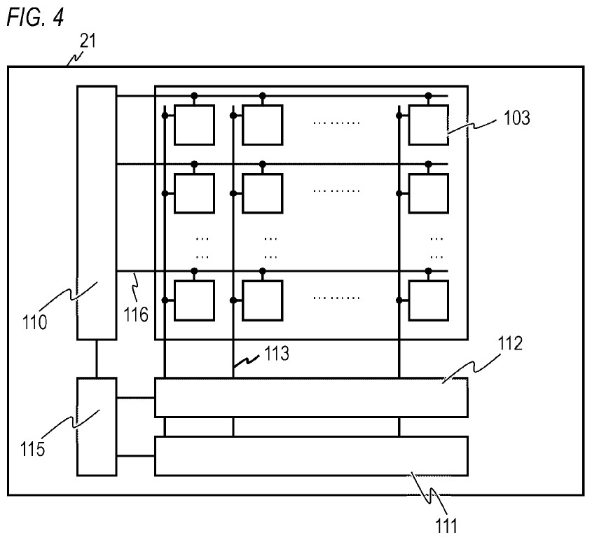

FIG. 4 shows the configuration of the circuit board 21. The circuit board 21 has the signal processing units 103 that processes the charge photoelectrically-converted in the photoelectric conversion elements 102 of FIG. 3, a TDC device 112, a control pulse generating unit 115, a horizontal transfer circuit unit 111, vertical output lines 113, a vertical scanning circuit unit 110, and drive lines 116.

The photoelectric conversion elements 102 of FIG. 3, and the signal processing units 103 of FIG. 4 are electrically connected via connection wiring provided for each pixel.

The vertical scanning circuit unit 110 receives the control pulse supplied from the control pulse generating unit 115, and supplies the control pulse to each pixel via the drive lines 116. The vertical scanning circuit unit 110 outputs the control pulse, or a selection signal, to a drive line 116 corresponding to a row of pixels where signals are to be read out, and thereby, functions as a row selection circuit via which one row of pixels is selected. A logic circuit such as a shift register and an address decoder is used for the vertical scanning circuit unit 110.

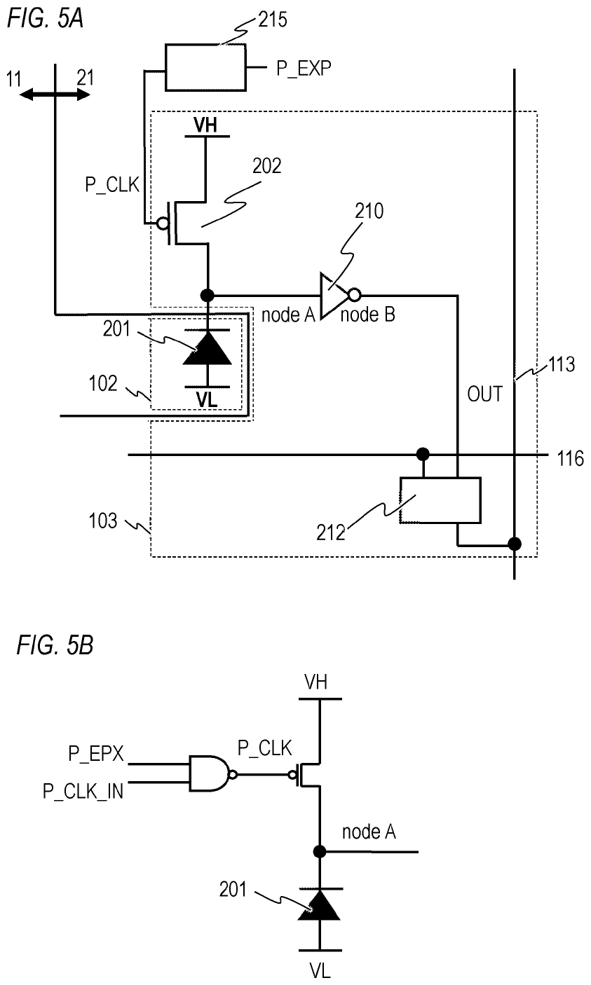

The control pulse generating unit 115 has a signal generating unit 215 that generates the undermentioned control signal for a switch, P_CLK. As described later, the signal generating unit 215 generates a pulse signal for controlling a switch. For example, as shown in FIG. 5A, the signal generating unit 215 may generate a common control signal P_CLK to a plurality of the pixels in the pixel region, or, as shown in FIG. 5B, may generate the control signals P_CLK for the respective pixels. The common control signal P_CLK is generated by matching, to the exposure period, at least one of the cycle, the number of pulses, and the pulse width of a pulse signal P_EXP that is a signal for controlling the exposure period. When controlled for the respective pixels, the control signals P_CLK can be generated using both an input signal P_CLK_IN that is outputted from the control pulse generating unit 115, and the signal P_EXP which is to control the exposure period. For example, the control pulse generating unit 115 preferably has a frequency divider circuit. This allows simple control, and can suppress an increase in the number of the elements.

The signals outputted from the photoelectric conversion elements 102 of the respective pixels are processed in the signal processing units 103. Pixel signals are outputted to the vertical output lines 113 from the signal processing units 103 of the pixels belonging to the row selected by the vertical scanning circuit unit 110. These pixel signals are inputted to the TDC device 112 as stop signals. The TDC device 112 is a device with which the time information, or digital values, indicating the timing when the stop signals are inputted, that is, the timing when the photoelectric conversion elements 102 detect the light is acquired. The horizontal transfer circuit unit 111 is a circuit via which the time information of each row is read out from a memory of the TDC device 112. The read-out time information of one row of the pixels is transmitted to the image processing circuit 153 of FIG. 1.

In FIG. 3, the pixels 101 on the pixel region 12 may be one-dimensionally aligned. It is not always necessary for all the pixels 101 to have the function of the signal processing units 103. For example, one signal processing unit 103 may be shared by a plurality of the pixels 101 to sequentially perform signal processing.

FIGS. 5A and 5B each show one example of a block diagram including an equivalent circuit of FIGS. 2 and 3. FIG. 5A shows an example of providing the common signal generating unit 215 for a plurality of the pixels. FIG. 5B shows an example where the control signal P_CLK can be controlled for each pixel.

FIG. 5A will be described. In FIG. 5A, the photoelectric conversion element 102 having an APD 201 is provided on the sensor substrate 11, and the other members are provided on the circuit board 21.

The APD 201 generates, through photoelectric conversion, charge pairs corresponding to incident light. A voltage VL, or a first voltage, is supplied to the anode of the APD 201, and a voltage VH, or a second voltage, that is higher than the voltage VL supplied to the anode is supplied to the cathode of the APD 201. A reverse bias voltage that causes the APD 201 to perform an avalanche multiplication operation is supplied to the anode and the cathode of the APD 201. The state where such a voltage is supplied leads to avalanche multiplication caused by the charge generated by the incident light to generate an avalanche current.

A reverse bias voltage is supplied in a Geiger mode of performing the operation with a potential difference between the anode and the cathode larger than a breakdown voltage, or in a linear mode of performing the operation with a potential difference between the anode and the cathode in the vicinity or not more than the breakdown voltage. An APD operated in the Geiger mode is referred to as a single photon avalanche diode (SPAD). For example, the voltage VL or the first voltage is −30 V, and the voltage VH or the second voltage is 1 V. The APD 201 may be operated in the linear mode, or may be operated in the Geiger mode. In the case of an SPAD, the potential difference is larger than in the case where the APD is in the linear mode, and the pressure resistance effect is remarkable.

A switch 202 is connected to a power supply line and the APD 201 to which the drive voltage VH is supplied. The switch 202 is connected to one node of the anode and the cathode of the APD 201. With the switch 202, the potential difference between the anode and the cathode of the APD 201 is switched between a first potential difference that causes avalanche multiplication, and a second potential difference that does not cause avalanche multiplication. Hereinafter switching from the second potential difference to the first potential difference will be also referred to as on of the switch 202, and switching from the first potential difference to the second potential difference will be also referred to as off of the switch 202. The switch 202 functions as a quench device. The switch 202 has the function as a load circuit, or a quenching circuit, in signal multiplication by avalanche multiplication to reduce the voltage to be supplied to the APD 201 to suppress avalanche multiplication, which is referred to as a quench operation. The switch 202 also has the function of returning, to the drive voltage VH, the voltage to be supplied to the APD 201 by flowing a current corresponding to a voltage drop caused by the quench operation, which is referred to as a recharge operation. That is, the switch 202 functions as a control circuit via which the occurrence of avalanche multiplication in the APD 201 is controlled.

For example, the switch 202 can be configured by a MOS transistor. The control signal P_CLK for the switch 202 supplied from the signal generating unit 215 is applied to a gate electrode of the MOS transistor configuring the switch 202. In the present embodiment, the on and off of the switch 202 are controlled by controlling the applied voltage to the gate electrode of the switch 202.

The signal processing unit 103 has a waveform shaping unit 210 and a selection circuit 212. In this specification, the signal processing unit 103 is only required to have at least one of the waveform shaping unit 210 and the selection circuit 212. A counter circuit that counts the pulse signals outputted from the waveform shaping unit 210 may be provided at a stage later than the waveform shaping unit 210.

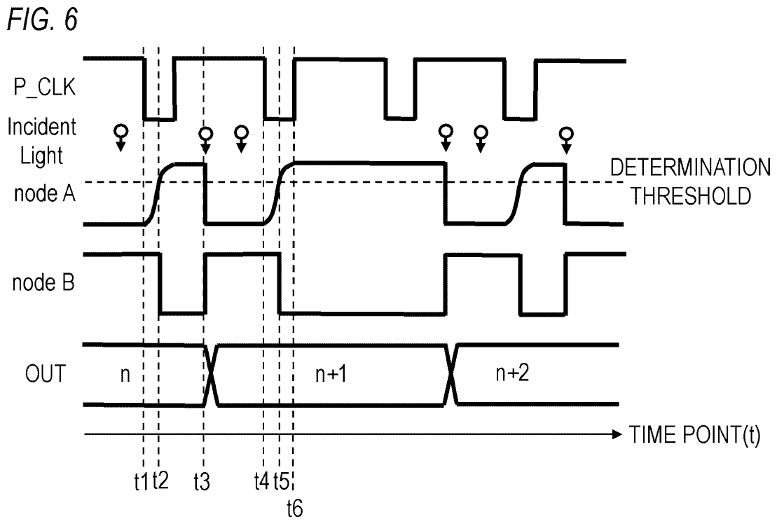

The waveform shaping unit 210 shapes a potential change at the cathode of the APD 201 that is acquired in photon detection, and outputs the pulse signals. The node of the waveform shaping unit 210 on the input side is defined as a node A, and the node thereof on the output side is defined as a node B. The waveform shaping unit 210 changes the potential to be outputted from the node B depending on whether the potential inputted to the node A is at least or is lower than a predetermined value. For example, in FIG. 6, when the potential inputted to the node A is a high potential of at least a determination threshold, the potential outputted from the node B is at the low level; and when the potential inputted to the node A is a potential lower than the determination threshold, the potential outputted from the node B is at the high level. For example, an inverter circuit is used as the waveform shaping unit 210. FIG. 5A shows an example of using one inverter as the waveform shaping unit 210. However, a circuit of a plurality of inverters connected in series may be used, or another type of a circuit having a waveform shaping effect may be used.

While the quench operation and the recharge operation using the switch 202 can be performed according to the avalanche multiplication in the APD 201, some timing of photon detection may cause the charge generated in the APD 201 not to be determined as an output signal. For example, it is assumed that avalanche multiplication occurs in the APD 201, the node A is at the low level, and the recharge operation is being performed. Generally, the determination threshold for the waveform shaping unit 210 is set in a potential higher than a potential difference causing avalanche multiplication in the APD 201. Entrance of a photon to the APD 201 when the potential at the node A is lower than the determination threshold due to the recharge operation and is a potential that can cause avalanche multiplication in the APD 201 causes avalanche multiplication in the APD 201 to cause the voltage at the node A to drop. That is, because the potential at the node A drops at a voltage lower than the determination threshold, no potential change over the determination threshold occurs, and the potential outputted from the node B does not change. Therefore, although avalanche multiplication occurs, photon detection is not determined as a signal. Especially under a high illuminance, photons consecutively enter the APD 201 in a short period, and thus, the incident light is difficult to be determined as signals. For this reason, in spite of a high illuminance, the actual number of entered incident photons, and the output signal tend to deviate from each other.

In contrast to this, the control signal P_CLK is applied to the switch 202 to switch the state of the switch 202 between the on and off; thereby, photons can be determined as signals even when consecutively entering the APD 201 in a short time. FIG. 6 illustrates an example in which the control signal P_CLK is a pulse signal having repetition periods. In other words, FIG. 6 illustrates an aspect of switching the switch 202 between the on-state and the off-state at a predetermined clock frequency. Nevertheless, the effect of suppressing an increase in power consumption of the photoelectric conversion device 100 can be obtained even when the pulse signal is not a signal having repetition periods.

A control pulse pSEL is supplied to the selection circuit 212 from the vertical scanning circuit unit 110 of FIG. 4 via the drive line 116 to switch the waveform shaping unit 210 and the vertical output line 113 between an electrically connected state and separate state. For example, the selection circuit 212 includes a buffer circuit for outputting signals.

Electric connection may be switched by arranging (a) switch(es) such as a transistor between the switch 202 and the APD 201, and/or between the photoelectric conversion element 102 and the signal processing unit 103. Likewise, the supply of the voltage VH or voltage VL to be supplied to the photoelectric conversion element 102 may be electrically switched using a switch such as a transistor.

FIG. 6 schematically shows the relationship between the control signal P_CLK for the switch, the potential at the node A, the potential at the node B, and the output signal. In the present embodiment, the control signal P_CLK at the high level leads to a state where the drive voltage VH is difficult to be supplied to the APD 201, and the control signal P_CLK at the low level leads to a state where the drive voltage VH is supplied to the APD 201. For example, the control signal P_CLK at the high level is at 1 V, and the control signal P_CLK at the low level is 0 V. The switch is in the off when the control signal P_CLK is at the high level, and is in the on when the control signal P_CLK is at the low level. The resistance value of the switch when the control signal P_CLK is at the high level is higher than the resistance value of the switch when the control signal P_CLK is at the low level. When the control signal P_CLK is at the high level, the recharge operation is difficult to be performed even when avalanche multiplication occurs in the APD 201, and thus, the potential supplied to the APD 201 is a potential not more than the breakdown voltage of the APD 201. Therefore, the operation of avalanche multiplication in the APD 201 stops.

As shown in FIG. 5A, preferably, the switch 202 is configured of one transistor, and the quench operation and the recharge operation are performed using the one transistor. This can reduce the number of the circuits compared with the case where the quench operation and the recharge operation are performed using different circuit elements.

At a time point t1, the control signal P_CLK changes from the high level to the low level, which causes the switch to be in the on, and the recharge operation of the APD 201 to be started. The potential at the cathode of the APD 201 thereby transitions to the high level. Then, the potential difference between the potentials applied to the anode and the cathode of the APD 201 is in a state where avalanche multiplication can occur. The potential at the cathode is the same as the potential at the node A. Therefore, when the potential at the cathode transitions from the low level to the high level, the potential at the node A is at least the determination threshold at a time point t2. At this time, the pulse signal outputted from the node B is inverted from the high level to the low level. Thereafter, the APD 201 is in a state where the potential difference equal to the result of the drive voltage VH−the drive voltage VL is applied thereto. The control signal P_CLK becomes the high level, and the switch is in the off.

When a photon enters the APD 201 at a time point t3, avalanche multiplication occurs in the APD 201, and the voltage at the cathode drops. In short, the voltage at the node A drops. When the amount of the voltage drop further increases and the potential difference applied to the APD 201 becomes small, avalanche multiplication in the APD 201 stops as at the time point t2, and the voltage level at the node A does not drop more than a certain fixed value. When the voltage at the node A is lower than the determination threshold while being dropping, the voltage at the node B changes from the low level to the high level. In short, the portion of the output waveform of the node A that exceeds the determination threshold is subjected to waveform shaping in the waveform shaping unit 210 to be outputted as a signal at the node B.

Between the time point t3 and a time point t4, a photon enters the APD 201, whereas the switch is in the off-state, and the applied voltage to the APD 201 does not have a potential difference that can cause avalanche multiplication. Therefore, the voltage level at the node A does not exceed the determination threshold.

At the time point t4, the control signal P_CLK changes from the high level to the low level, and the switch is in the on. Following this, a current to compensate for the voltage drop flows from the drive voltage VH to the node A, and the voltage at the node A transitions to the original voltage level. At this time, because the voltage at the node A is at least the determination threshold at a time point t5, the pulse signal at the node B is inverted from the high level to the low level.

At a time point t6, the voltage level at the node A is statically settled at the original voltage level, and the control signal P_CLK changes from the low level to the high level. Therefore, the switch is in the off. Subsequently, the potentials at each node, signal lines, etc. change according to the control signal P_CLK and the entrance of photons as described for the time point t1 to the time point t6.

Hereinafter examples of the configuration of the TDC device will be described in more detail.

### First Embodiment

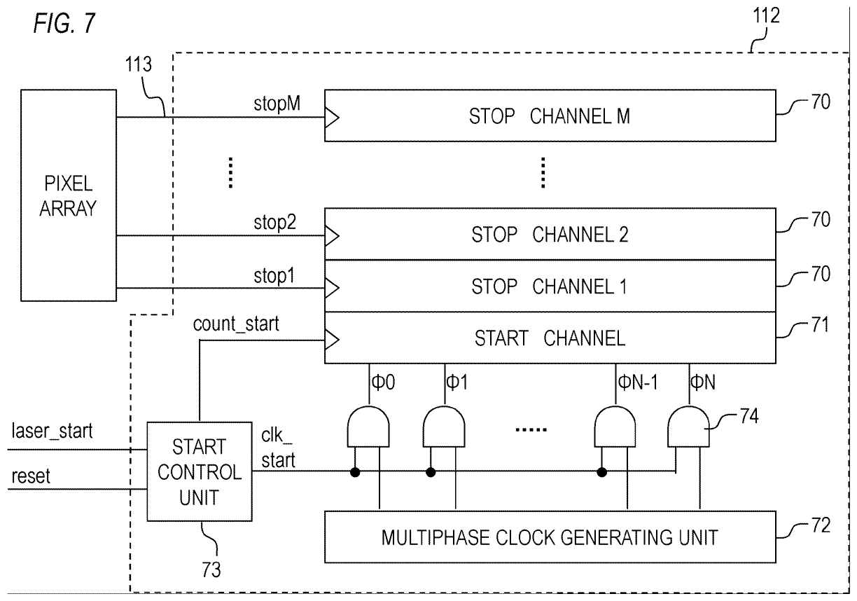

FIG. 7 schematically shows the configuration of the TDC device 112 according to the first embodiment.

The TDC device 112 is a multi-channel TDC or an M-input TDC having M stop channels, and has M TDC circuits 70 which operate in parallel. The TDC device 112 includes a start circuit 71, a multiphase clock generating unit 72, a start control unit 73, and N+1 AND circuits 74.

The M TDC circuits 70 correspond to M columns of pixels in the pixel array.

That is, the M TDC circuits 70 are connected to the M vertical output lines 113 of the pixel array, respectively; and the pixel signals outputted from the M pixels in the row selected by the vertical scanning circuit unit 110 are inputted to the corresponding TDC circuits 70 or stop channels as stop signals. This enables the operation of the TDC in the one row to be executed in parallel, and can realize ranging at a high frame rate.

The start circuit 71 is a circuit that supplies start signals to the TDC circuits 70. When a count start signal count_start is inputted from the start control unit 73, the start circuit 71 supplies start signals to the M TDC circuits 70 to allow the counting operation of the M TDC circuits 70 to be simultaneously started.

The multiphase clock generating unit 72 is a circuit that generates a common clock signal to be supplied to the M TDC circuits 70. The multiphase clock generating unit 72 generates multiphase clock signals each configured by a plurality of clock signals φ0 to φN that are out of phase with each other. The phase difference in the multiphase clock signal determines the temporal resolution of the TDC circuits 70. In this embodiment, for example, a multiphase clock signal of 1.25 GHz and eight phases is used. The phase difference, that is, the temporal resolution in this case is 100 psec. This value of the temporal resolution is one example, and the temporal resolution may be designed as appropriate according to the requirements specification of the ranging apparatus 1.

The output terminals of the multiphase clock generating unit 72 are connected to corresponding respective input terminals of the AND circuits 74. When clock supply start signals clk_start are inputted from the start control unit 73 to the respective AND circuits 74, the multiphase clock signals are simultaneously supplied to the M TDC circuits 70. That is, in this embodiment, the combination of the multiphase clock generating unit 72 and the AND circuits 74 realizes a clock supply unit that simultaneously supplies a common clock signal to a plurality of the TDC circuits 70.

The start control unit 73 is a circuit that controls the timing when the common clock signal is supplied to the TDC circuits 70, that is, a clock supply timing, and the timing when the TDC circuits 70 start to execute the counting operation, that is, a count start timing. In this embodiment, the start control unit 73 controls the count start timing, so that the counting operation of the TDC circuits 70 begins after a predetermined delay time τ has passed since the clock supply timing. Preferably, the delay time τ is set to have a length necessary for power-supply fluctuations in the TDC circuits 70 which can occur by simultaneous supply of the common clock signal to be stabilized so as not to influence the TDC operation. For example, the delay time τ is set in approximately several hundred picoseconds to several nanoseconds. The behavior of the power-supply fluctuations changes depending on the number of the channels of the TDC circuits 70, the capacity of an external power supply system supplying electric power to the TDC device 112, etc. Therefore, it is preferable to do experiments under various assumed conditions, and set an appropriate delay time τ. Even when simultaneous supply of the common clock signal causes the power-supply fluctuations, the counting operation starts after the power-supply fluctuations disappear or are sufficiently stabilized because the delay time τ as described above is provided. Thus, faults in the TDC circuits due to the power-supply fluctuations can be prevented in advance.

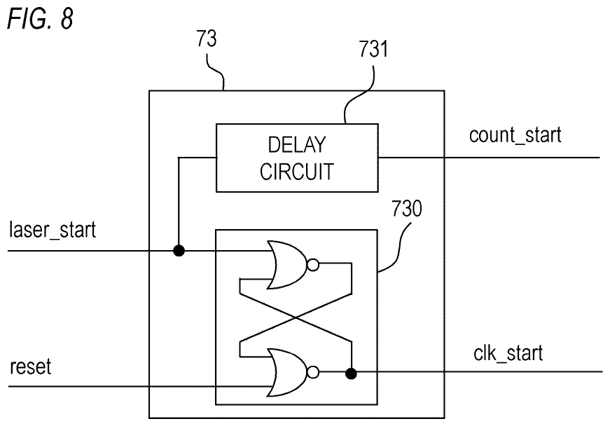

FIG. 8 shows an example of the configuration of the start control unit 73. The start control unit 73 according to this embodiment is configured by a latch circuit 730 and a delay circuit 731, and generates the clock supply start signals clk_start and the count start signal count_start on the basis of an emission timing signal laser_start. The emission timing signal laser_start is a signal synchronizing the timing when the light source 151 emits the light, and is supplied from the control unit 150 (FIG. 1) or the control pulse generating unit 115 (FIG. 4).

The latch circuit 730 is configured by an SR latch that is the combination of two NOR circuits, and the emission timing signal laser_start is inputted to a Set terminal thereof. A reset signal “reset” supplied from the control pulse generating unit 115 (FIG. 4) is inputted to a Reset terminal of the latch circuit 730. The reset signal “reset” is a signal for resetting the counting operation to restore the TDC circuits to the initial state. The counting operation is reset before counting for each row is started.

The delay circuit 731 is a generating unit that generates the count start signal count_start by delaying the emission timing signal laser_start for a predetermined delay time τ. For example, the delay circuit 731 is configured by an inverter chain, a flip-flop, or the like.

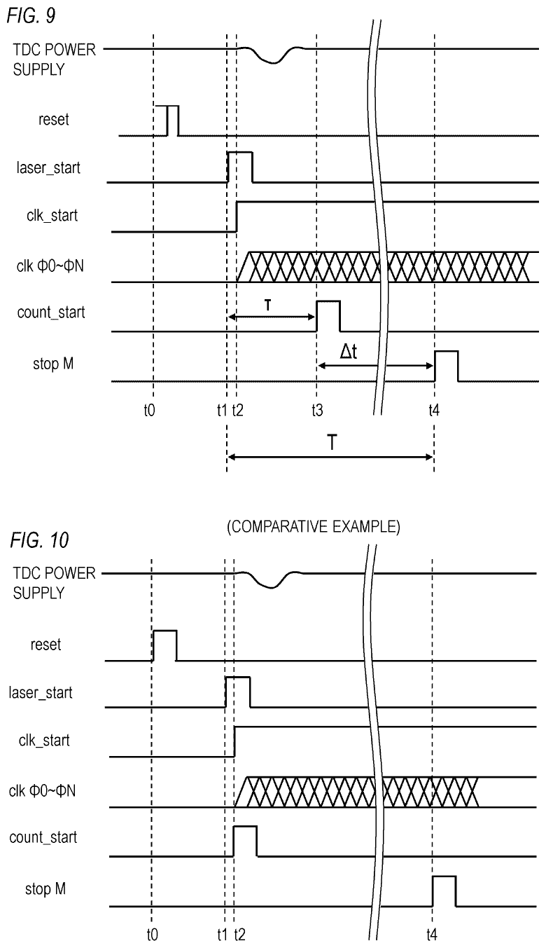

The effect of the start control according to the first embodiment will be described using FIGS. 9 and 10. FIG. 9 shows an example of a timing chart of the start control according to the first embodiment, and FIG. 10 shows an example of a timing chart of start control according to a comparative example.

First, the start control according to the first embodiment will be described with reference to FIG. 9.

When the reset signal “reset” is inputted to the start control unit 73 at a time point t0, the latch circuit 730 is reset, and the clock supply start signals clk_start are in Low. This causes the gates of the AND circuits 74 to close to be in a state where the multiphase clock signals are not supplied to the TDC circuits 70.

When the emission timing signal laser_start is inputted to the start control unit 73 at a time point t1, the S terminal of the latch circuit 730 becomes High. As a result, at a time point t2, the clock supply start signals clk_start, which are the Q output of the latch circuit 730, become High. This state is being held until the next reset.

When the clock supply start signals clk_start become High at the time point t2, the gates of the AND circuits 74 open, and the multiphase clock signals φ0 to φN are supplied to the M TDC circuits 70 simultaneously. At this time, power-supply fluctuations in the TDC circuits 70 occur due to a sudden change in amount of current flowing in the circuit.

After the power supply voltage for the TDC circuits 70 is sufficiently stabilized, the count start signals count_start are outputted from the delay circuit 731 of the start control unit 73 at a time point t3. When the count start signals count_start are supplied to the respective TDC circuits 70 via the start circuit 71, counting the clock signal is started in each of the TDC circuits 70.

When the stop signals outputted from the pixels having detected the reflected light are inputted to the TDC circuits 70, the TDC circuits 70 stop the counting operation, and at this time, the count values are latched. For example, as in FIG. 9, when the stop signal is inputted at a time point t4, the count value corresponding to the time difference Δt between the count starting timing t3 and the timing when the stop signal is inputted t4 is acquired. This count value corresponds to the time information indicating the timing when the photoelectric conversion element 102 detects the light, that is, a time point t4. In signal processing at a later stage, the time-of-flight of the light T, that is, t4−t1=Δt+τ, can be calculated by calculating Δt from the count value, and the phase difference in the clock signal, and adding the delay time τ. Further, the distance d to the subject can be acquired from the following formula: d=c×T/2, where c is a light velocity.

According to the aforementioned start control of this embodiment, even when simultaneous supply of the common clock signal causes the power-supply fluctuations, the counting operation starts after the power-supply fluctuations disappear or are sufficiently stabilized. Thus, faults in the TDC circuits due to the power-supply fluctuations can be prevented in advance. Therefore, the distance d to the subject can be measured with a high precision.

Against this, in the comparative example shown in FIG. 10, the delay time τ is not set but the multiphase clock signals φ0 to φN are supplied simultaneously at the time point t2, and at the same time, the counting operation by the TDC circuits is started. In the case of the control as in the comparative example, it is found that power-supply fluctuations occur immediately after the start of the counting operation. Such power-supply fluctuations may lead to malfunction in the counting operation, which causes faults in the TDC device 112, and moreover, failure or a decreased precision in ranging.

### Second Embodiment

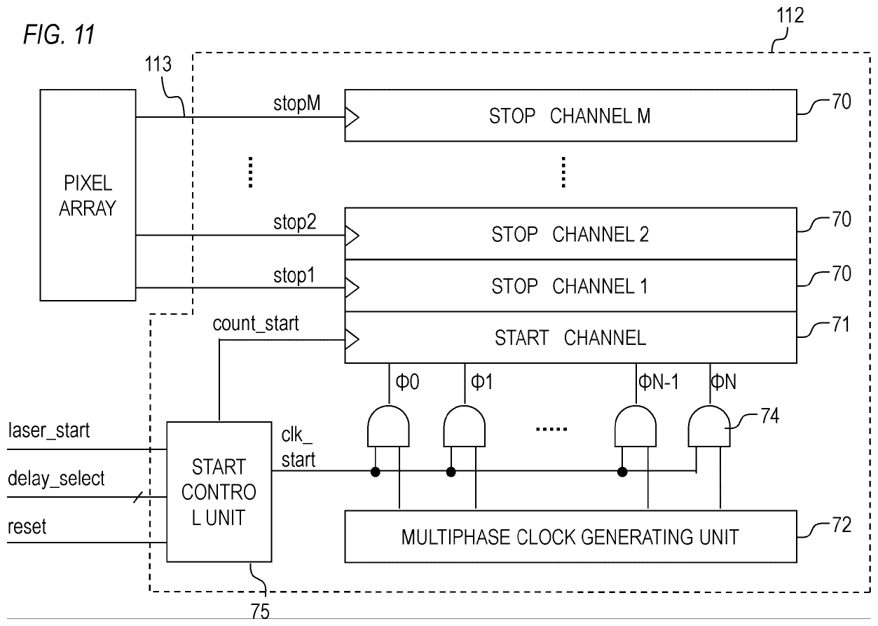

The TDC device 112 according to the second embodiment will be described with reference to FIGS. 11 to 13. The difference from the first embodiment is that a start control unit 75 can change the delayed volume of the count start signal count_start. The other configuration is the same as in the first embodiment, and thus, the configuration particular in the second embodiment will be mainly described in the following.

As shown in FIG. 11, the TDC device 112 according to the second embodiment is configured by the M TDC circuits 70, the start circuit 71, the multiphase clock generating unit 72, a start control unit 75, and the N+1 AND circuits 74. To the start control unit 75, the emission timing signal laser_start, the reset signal “reset”, and a delayed volume selection signal delay_select are inputted from the control unit 150 (FIG. 1) or the control pulse generating unit 115 (FIG. 4).

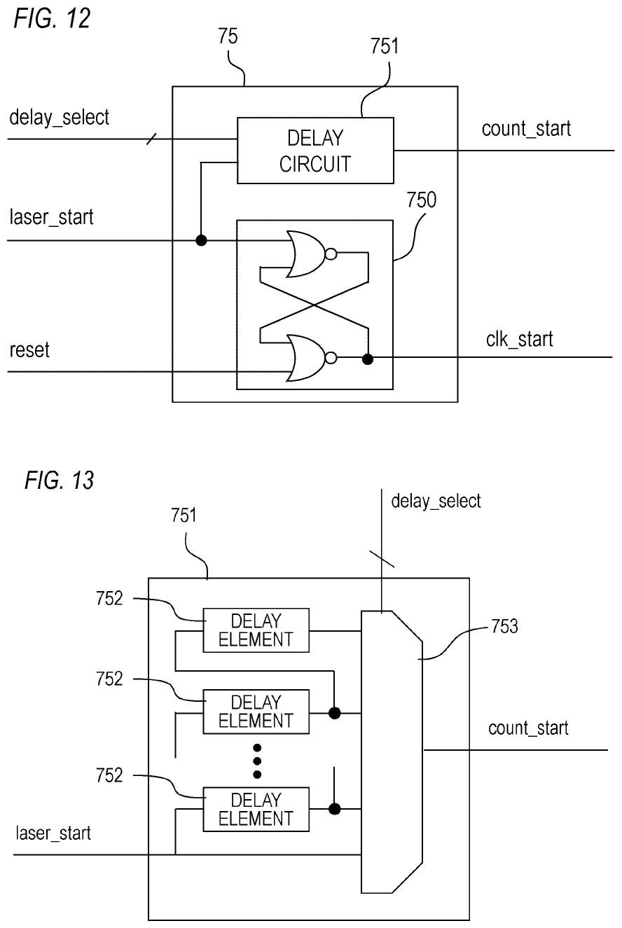

As shown in FIG. 12, the start control unit 75 according to this embodiment is configured by a latch circuit 750 and a delay circuit 751. The latch circuit 750 is the same as the latch circuit 730 according to the first embodiment (FIG. 8). The delay circuit 751 is a generating unit that generates the count start signal count_start by delaying the emission timing signal laser_start. While the delayed volume by the delay circuit 731 according to the first embodiment is fixed, the delay circuit 751 according to the second embodiment can change the delayed volume by the delayed volume selection signal delay_select.

FIG. 13 shows an example of the configuration of the delay circuit 751. The delay circuit 751 has a plurality of delay elements 752 connected in series, and a selector 753. To the selector 753, the emission timing signal laser_start, and the output of each of the delay elements 752 are inputted, and a signal to be outputted as the count start signal count_start can be selected by the delayed volume selection signal delay_select. When the emission timing signal laser_start is selected, the count start signal count_start synchronizing the emission timing signal laser_start without any delayed volume is outputted. When the output of any of the delay elements 752 is selected, the count start signal count_start delaying further than the emission timing signal laser_start is outputted. The larger the number of the stages of the delay elements 752 to pass is, the larger the delayed volume is.

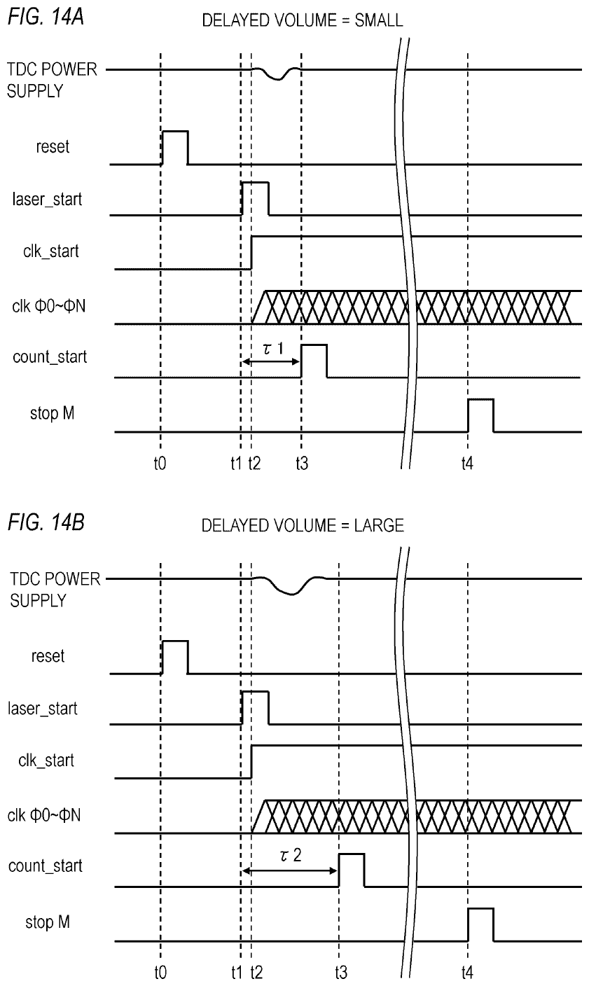

The effect of the start control according to the second embodiment will be described with reference to FIGS. 14A and 14B. For example, the behavior of the power-supply fluctuations changes depending on the number of the channels of the TDC circuits 70, the capacity of an external power supply system supplying electric power to the TDC device 112, etc. FIG. 14A shows an example of small power-supply fluctuations, and FIG. 14B shows an example of large power-supply fluctuations. As in FIG. 14A, when the power-supply fluctuations are small, the delayed volume τ1 may be set small. In contrast, as in FIG. 14B, when the power-supply fluctuations are large, the delayed volume τ2 is set large. When it is expected that the power-supply fluctuations do not occur or is sufficiently small, no delayed volume is set.

When the stop signal is inputted after the light is emitted before the counting operation is started during the period from a time point t1 to a time point t3, no counting is performed, and the distance information cannot be acquired. In other words, the delayed volume affects the minimum distance which can be ranged. Therefore, increasing the delayed volume in vain is not proper, and preferably, the delayed volume is determined in view of the balance between the risk of the faults due to power-supply fluctuations, and the range where ranging can be performed. According to the configuration of this embodiment, the optimization of the delayed volume can be achieved in view of the structure, the use, and the requirements specification of the ranging apparatus 1, the performance of an external power supply system, etc. Thus, the convenience and flexibility of the ranging apparatus 1 can be enhanced. When the optimum delayed volume is predicted, this delayed volume may be preset for the ranging apparatus 1. A user may change the setting value of the delayed volume. Alternatively, in the ranging apparatus 1, the occurrence or not, and the degree of the power-supply fluctuations may be detected to carry out calibration so as to set the optimum delayed volume.

### Third Embodiment

In the first and second embodiments, the configuration using avalanche photodiodes as photoelectric conversion elements are described. In the third embodiment, a charge-accumulating photodiode is used as a photoelectric conversion element. The other configuration including the configuration of the TDC device may be the same as in the first or second embodiment, and thus, only the circuit of a pixel, which is the configuration particular in the third embodiment, will be described in the following.

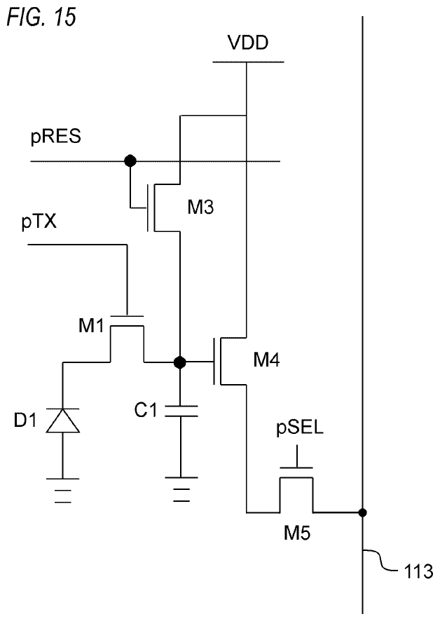

FIG. 15 shows an equivalent circuit of a pixel using a charge-accumulating photodiode. In the following description, the charge accumulated in the photodiode that is a photoelectric conversion element is an electron, and the transistors provided for the pixels are all N-type transistors. The charge accumulated in the photodiode is not limited to an electron, but may be a hole. In the case of a hole, the transistor of the pixel may be a P-type transistor. In short, the definition of the conductivity type used in the following description can be changed according to the polarity of the charge to be treated as a signal.

The pixel has a photodiode D1, a transfer transistor M1, a charge conversion part C1, a reset transistor M3, an amplification transistor M4, and a selection transistor M5.

The photodiode D1 is a photoelectric conversion element that converts the entered light to charge. The transfer transistor M1 is provided in the electric path between the node at which the charge conversion part C1, the reset transistor M3, and the amplification transistor M4 are connected, and the photodiode D1. One end of the source or the drain of the reset transistor M3 is connected to the node common to the charge conversion part C1 and the amplification transistor M4, and a power supply voltage VDD is applied to the other end thereof. The gate of the amplification transistor M4 is connected to the node common to the charge conversion part C1, and the source or the drain of the reset transistor M3. The power supply voltage VDD is applied to one end of the source or the drain of the amplification transistor M4, and the other end thereof is connected to one end of the source or the drain of the selection transistor M5. The selection transistor M5 is provided in the electric path between the amplification transistor M4 and the vertical output line 113. In other words, the amplification transistor M4 is electrically connected to the vertical output line 113 via the selection transistor M5. The charge conversion part C1 corresponds to a floating diffusion part, and has a capacity including the capacity of floating diffusion provided in a semiconductor substrate, and the parasitic capacitance of the electric path from the transfer transistor M1 to the amplification transistor M4 via the capacity of the floating diffusion. The capacity of the floating diffusion is actually provided as a wiring capacity.

The signals pRES, pTx, and pSEL in FIG. 15 are the control signals supplied from the vertical scanning circuit unit 110 shown in FIG. 4 to the pixel. The signal pTx is supplied to the gate of the transfer transistor M1. The signal pRES is supplied to the gate of the reset transistor M3, and the signal pSEL is supplied to the gate of the selection transistor M5.

A current source which is not shown is connected to the vertical output line 113. When the signal pSEL supplied to the gate of the selection transistor M5 is at an active level, the selection transistor M5 is turned on. This allows an electric current to be supplied from the current source to the amplification transistor M4. In the pixel, a source follower circuit is formed of the power supply voltage VDD, the amplification transistor M4, and the current source which is not shown and connected to the vertical output line 113. Via this source follower circuit, the signal based on the potential of the charge conversion part C1 is outputted to the vertical output line 113 via the transistor M5.

By the vertical scanning circuit unit 110, the signal pTx to be outputted to the pixels located in the row of the pixels, where the signal pSEL is at an active level, is set to be at an active level for the entire period when the signal pSEL is at an active level. This changes, at the timing when a signal, or the reflected light from the subject for laser light is inputted to the photodiode D1 during the time period when the signal pSEL is at an active level, the level of the signal outputted from the amplification transistor M4. This change in signal level is inputted to the TDC circuits 70 via the vertical output line 113 as the stop signal. By this, the time information of digital signals that shows the timing when the signal, or the reflected light from the subject for laser light, is inputted to the photodiode can be acquired.

The aspect of directly connecting the photodiode D1, and the gate of the amplification transistor M4 without providing the transfer transistor M1 can be also used.

The configuration described above also brings about the operation and effect same as in the first or second embodiment.

### Fourth Embodiment

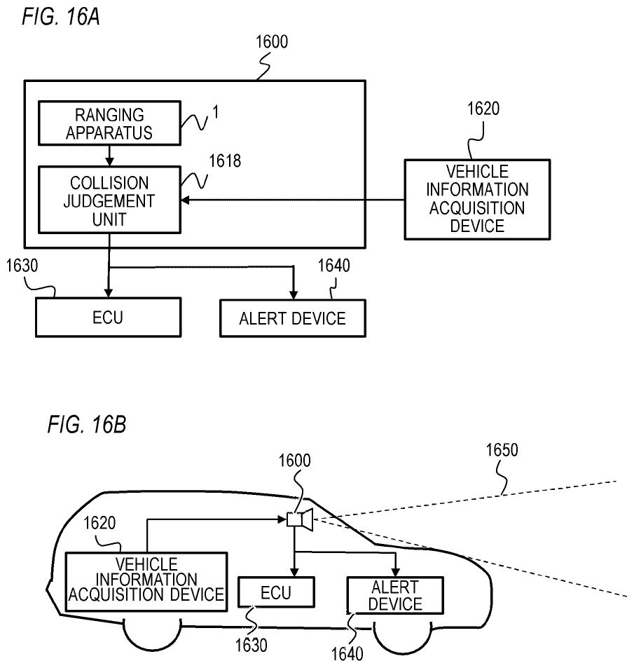

A ranging apparatus and a movable body according to this embodiment will be described using FIGS. 16A and 16B. FIG. 16A shows the configuration of a vehicle-mounted camera system provided with the ranging apparatus according to this embodiment, and FIG. 16B shows the configuration of the movable body according to this embodiment.

As shown in FIG. 16A, a vehicle-mounted camera system 1600 has the ranging apparatus 1 that measures the distance to an object, and a collision judgement unit 1618 that judges whether there is the likelihood of collision or not based on the measured distance. Here, the ranging apparatus 1 is the TOF sensor described in the first to third embodiments. All or a part of the functions of the vehicle-mounted camera system 1600 may be realized by dedicatedly designed hardware or may be realized by a software module; and further, may be realized by a field programmable gate array (FPGA), an application specific integrated circuit (ASIC), or the like, or may be realized by any combination thereof.

The vehicle-mounted camera system 1600 is connected to a vehicle information acquisition device 1620, and can acquire vehicle information on the vehicle speed, the yaw rate, the steering angle, etc. Further, to the vehicle-mounted camera system 1600, an ECU 1630 that is a control device that outputs control signals for generating a braking force for the vehicle based on the determination results in the collision judgement unit 1618 is connected. Further, the vehicle-mounted camera system 1600 is also connected to an alert device 1640 that issues alerts to the driver based on the determination results in the collision judgement unit 1618. For example, when the likelihood of collision is high as the determination results of the collision judgement unit 1618, the ECU 1630 performs vehicle control to avoid a collision or reduce damage by applying the brakes, raising the accelerator, suppressing the engine power, etc. The alert device 1640 alerts a user by sounding alerts such as noises, displaying alert information on a screen of a car navigation system or the like, vibrating seat belts and/or steering wheels, etc.

In the present embodiment, an area around the vehicle, for example, an area in the front or rear of the vehicle is imaged using the vehicle-mounted camera system 1600. FIG. 16B shows the vehicle-mounted camera system when an area in the front of the vehicle, that is, an imaging area 1650 is imaged. The vehicle information acquisition device 1620 transmits instructions to the vehicle-mounted camera system 1600. Such configuration can further improve the precision in ranging.

While the example of the control so as not to collide with any other vehicles has been described above, the present embodiment can be applied to control to perform automatic driving following any other vehicles, control to perform automatic driving so as not to run off traffic lanes, etc. Furthermore, the vehicle-mounted camera system can be applied to any movable bodies or moving apparatuses such as ships, aircrafts, and industrial robots without limitations to vehicles such as automobiles. Such a movable body includes one or both of a driving force generating unit that generates a driving force mainly utilized for movement thereof, and a rotating member mainly utilized for movement thereof. The driving force generating unit can include engines, motors, etc. The rotating member can include tires, wheels, screws for ships, propellers for flight vehicles, etc. In addition, the present embodiment can be widely applied to devices utilizing object recognition without limitations to movable bodies, which include intelligent transportation systems (ITSs).

### Fifth Embodiment

For example, the abovementioned photoelectric conversion device and ranging apparatus may be applied to electronic devices such as so-called smartphones and tablets.

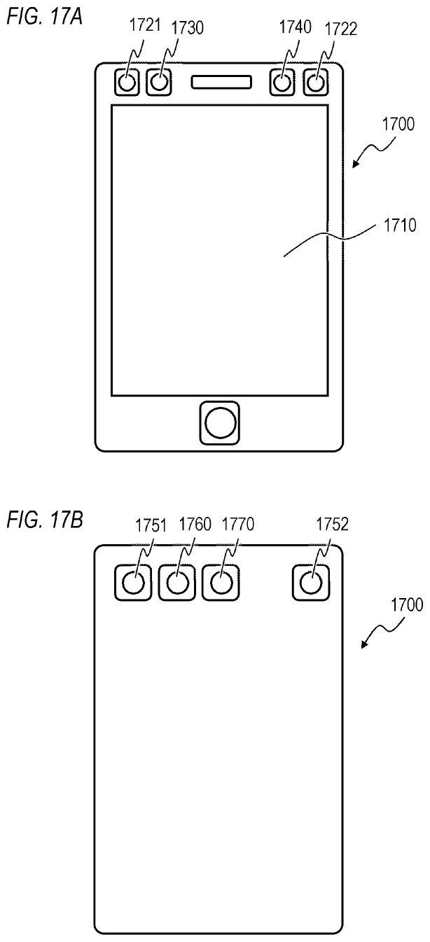

FIGS. 17A and 17B show one example of an electronic device 1700 in which a photoelectric conversion device is installed. FIG. 17A shows the front-face side of the electronic device 1700, and FIG. 17B shows the rear-face side of the electronic device 1700.

As shown in FIG. 17A, a display 1710 where images are to be displayed is arranged on the center of the front face of the electronic device 1700. Front cameras 1721 and 1722 that use the photoelectric conversion device, an IR light source 1730 that emits infrared light, and a visible light source 1740 that emits visible light are arranged along the top side of the front face of the electronic device 1700.

As shown in FIG. 17B, rear cameras 1751 and 1752 that use the photoelectric conversion device, an IR light source 1760 that emits infrared light, and a visible light source 1770 that emits visible light are arranged along the top side of the rear face of the electronic device 1700.

The electronic device 1700 formed in such a way can capture, for example, higher-grade images by applying the abovementioned photoelectric conversion device. The photoelectric conversion device can be applied to any other electronic devices such as infrared sensors, ranging apparatuses using active infrared light sources, security cameras, and identity or biometric authentication cameras. This can enhance the precision, the performance, etc. of such electronic devices.

### Other Embodiments

While in the above-described embodiments, the count start signal count_start is generated based on the emission timing signal laser_start, the method of generating the count start signal count_start is not limited to this. For example, the count start signal count_start may be generated based on any other signal synchronizing the emission timing of measuring light, or may be generated based on the clock supply start signal clk_start.

While the various devices have been described in the above-described embodiments, mechanical devices may be further included. A mechanical device in the camera can drive parts of an optical system for zooming, focusing, and shutter operations. Alternatively, a mechanical device in the camera can move the photoelectric conversion device for anti-vibration operations.

The devices can be transport devices such as vehicles, ships, and flight vehicles. A mechanical device in the transport device can be used as a moving apparatus. The device as the transport device is suitable for what transports the photoelectric conversion device, and what assists and/or automates driving or operation by a photographing function. A processor for assisting and/or automating driving or operation can carry out processes for operating the mechanical device as a moving apparatus based on information acquired in the photoelectric conversion device.

The above-described embodiments can be suitably changed as long as not deviating from the technical concept. The disclosure in this description includes not only the description therein but also all the matters graspable from the present description and the drawings appended to this description. The disclosure in this description encompasses a complement set of the concepts described in this description. That is, for example, when describing “A is larger than B”, the present description can be said to disclose “A is not larger than B” even when the “A is not larger than B” is omitted therein. This is because “A is larger than B” is described on the premise that the case where “A is not larger than B” is taken into account.

In this specification, the expression such as “A or B”, “at least one of A and B”, “at least one of A and/or B”, and “one or more of A and/or B” can encompass all the combinations of the listed items unless any explicit definition is mentioned in particular. That is, the foregoing expressions are understood to disclose all the cases where at least one A is encompassed, where at least one B is encompassed, and where both at least one A and at least one B are encompassed. This is also applied to the combinations of at least three elements in the same manner.

The influence of power-supply fluctuations can be avoided in a TDC device configured to supply a common clock signal to a plurality of TDC circuits.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-159942, filed on Sep. 25, 2023, which is hereby incorporated by reference herein in its entirety.

What is claimed is:

1. A time-to-digital converter (TDC) device comprising:
a plurality of TDC circuits;
a clock supply unit configured to supply a common clock signal to the TDC circuits; and
a start control unit configured to output a count start signal instructing a start timing of a counting operation to the TDC circuits, wherein
the start control unit outputs the count start signal after a predetermined delay time has passed since a timing when supply of the common clock signal is started from the clock supply unit to the TDC circuits.

2. The TDC device according to claim 1, wherein
the common clock signal supplied by the clock supply unit is a multiphase clock signal configured by a plurality of clock signals that are out of phase with each other.

3. The TDC device according to claim 1, wherein
the start control unit is configured to output a clock supply start signal instructing a supply start timing of the common clock signal to the clock supply unit, and controls an output timing of each of signals so as to output the count start signal after the predetermined delay time has passed since the clock supply start signal is output.

4. The TDC device according to claim 1, wherein
based on a signal outputted from a pixel having a photoelectric conversion element configured to detect light emitted from a light source and reflected on an object, the TDC device acquires time information indicating a timing when the photoelectric conversion element detects the light.

5. The TDC device according to claim 4, wherein
signals outputted from pixels that are different from each other are inputted to the TDC circuits respectively as stop signals to stop the counting operation.

6. The TDC device according to claim 4, wherein
the start control unit has a generating unit generating, based on an emission timing signal synchronizing a timing when the light source emits the light, the count start signal.

7. The TDC device according to claim 6, wherein
the generating unit is a delay circuit configured to delay the emission timing signal and thereby, generate the count start signal.

8. The TDC device according to claim 7, wherein
the delay circuit can change a delayed volume of the count start signal.

9. A ranging apparatus comprising:
a light source;
a plurality of pixels each having a photoelectric conversion element configured to detect light emitted from the light source and reflected on an object; and
a TDC device acquiring, based on signals outputted from the pixels, time information indicating a timing when the photoelectric conversion element of each of the pixels detects the light, wherein
the TDC device including:
a plurality of TDC circuits corresponding to the pixels;
a clock supply unit configured to supply a common clock signal to the TDC circuits; and
a start control unit configured to output a count start signal instructing a start timing of a counting operation to the TDC circuits, wherein
the start control unit outputs the count start signal after a predetermined delay time has passed since a timing when supply of the common clock signal is started from the clock supply unit to the TDC circuits.

10. The ranging apparatus according to claim 9, wherein
the common clock signal supplied by the clock supply unit is a multiphase clock signal configured by a plurality of clock signals that are out of phase with each other.

11. The ranging apparatus according to claim 9, wherein
the start control unit is configured to output a clock supply start signal instructing a supply start timing of the common clock signal to the clock supply unit, and controls an output timing of each of signals so as to output the count start signal after the predetermined delay time has passed since the clock supply start signal is output.

12. The ranging apparatus according to claim 9, wherein
signals outputted from pixels that are different from each other are inputted to the TDC circuits respectively as stop signals to stop the counting operation.

13. The ranging apparatus according to claim 12, wherein
the photoelectric conversion element is an avalanche photodiode.

14. The ranging apparatus according to claim 13, wherein
the avalanche photodiode is a SPAD operating in a Geiger mode.

15. The ranging apparatus according to claim 12, wherein
the photoelectric conversion element is a charge-accumulating photodiode.

16. The ranging apparatus according to claim 9, wherein
the start control unit has a generating unit generating, based on an emission timing signal synchronizing a timing when the light source emits the light, the count start signal.

17. The ranging apparatus according to claim 16, wherein
the generating unit is a delay circuit configured to delay the emission timing signal and thereby, generate the count start signal.

18. The ranging apparatus according to claim 17, wherein
the delay circuit can change a delayed volume of the count start signal.
